(19) United States
(12) Patent Application Publication
(10) Pub. No.: US 2008/0316891 A1
(43) Pub. Date: Dec. 25, 2008

(54) Optical Scanning Device

(75) Inventors: Joris Jan Vrehen, Eindhoven (NL); Johannes Matheus Marie De Wit, Helmond (NL)

Correspondence Address: BAINWOOD HUANG & ASSOCIATES LLC, 2 CONNECTOR ROAD, WESTBOROUGH, MA, 01581, US

(73) Assignee: ARIMA DEVICES CORPORATION, Road Town, Tortola (BV)

(21) Appl. No.: 12/091,347

(22) PCT Filed: Oct. 26, 2006
(86) PCT No.: PCT/EP2006/067839

§ 371 Date: Jun. 3, 2008

(30) Foreign Application Priority Data
Oct. 26, 2005 (EP) 05109997.6

(51) Int. Cl. G11B 7/00

(52) U.S. Cl. 369/94; 369/112.22; G9B/7

(57) ABSTRACT

An optical scanning device (3) for scanning a multiple of types of optical recording media. The optical scanning device is provided with a filtering means (301) that is arranged and configured such that when scanning an optical recording medium (15) having plurality of information layers (L0, L1) radiation reflected by another information layer than the information layer being scanned is not reaching the radiation detector (38), while the filtering means is substantially not affecting the radiation towards the radiation detector when another type of recording media is scanned. Improved data signal reproduction and tracking servo signals are obtained.

### FIELD OF THE INVENTION

The invention relates to optical data storage systems and, more particularly, to an apparatus and optical scanning device for scanning data stored on an optical recording medium having multiple information layers.

### BACKGROUND OF THE INVENTION

Optical data storage systems, i.e. optical recording systems or optical data drives, provide means for storage of large quantities of data on an optical recording medium, e.g. a disk. An optical scanning device in the optical data drive is used for scanning the information layer or layers of the media. Various optical data storage media formats and systems are well known and already commonly used, such as media according to the CD and DVD media standard, either for only reading data from prerecorded data such as ROM or Video, or for recording data on recordable or rewritable media such as CD-R, DVD+R, DVD-R or CD-RW, DVD+RW, DVD-RW, DVD-RAM.

CD media having a capacity of about 650 MB to 700 MB are recordable and readable using a semiconductor laser emitting a radiation beam having a wavelength of about 780 nm and an objective lens with a numerical aperture (NA) of 0.45 to about 0.55. The data is being read and/or written through a standard transparent layer of 1.2 mm thickness.

DVD media having a capacity of about 4.7 GB are recordable and readable using a semiconductor laser emitting a radiation beam having a wavelength of about 650 nm (a DVD radiation beam) and an objective lens with a NA of 0.60 to about 0.65. The standard transparent layer thickness of a DVD disk is 0.6 mm. In order to increase the total capacity of such media also dual information layer disks have been introduced for DVD read-only and recordable media having a capacity of about twice the capacity of a single information (data) layer disk. The separation between both information layers of a dual-layer DVD disk is about 55 μm.

A recently introduced higher capacity standard medium for a new media type of optical recording disk according to the Blu-ray Disc (BD) standard has a capacity of about 25 GB. The standard wavelength of the applied radiation beam is about 405 nm and the standard NA of the objective lens focusing the radiation beam onto the information layer is about 0.85. The radiation beam is focused through a standard transparent cover layer of 0.1 mm thickness. In view of even higher data storage capacity requirements BD also includes a dual-layer disk having a capacity of 50 GB. The spacing between both information layers of this dual-layer BD disk is about 25 μm. For even higher capacity requirements also more than two information layers is being worked on.

It is to be understood that an information layer of an optical recording medium can be a prerecorded information layer such as e.g. for data distribution, video distribution, etc., or a recordable information layer for e.g. data and/or video recording. Scanning an information layer may be considered to mean reading and/or recording e.g. data on such an information layer.

With increasing the capacity requirements, the dimensions of the data structures (bits) on the disk are decreasing from CD to DVD to BD. This is e.g. achieved by applying a reduction in the wavelength of the radiation beam and an increase in NA of the objective lens from the CD to the DVD to the BD system. The scanning spot dimension is proportional to λ/NA, hence a reduction in the scanning spot dimensions from about 1.5 μm in the CD system to about 1.0 μm in the DVD system to about 0.48 μm in the BD system. In order to generate a radiation spot of sufficient optical quality the optical scanning device in the optical data drive requires at least focusing and tracking controls in order to keep the scanning spot on track in axial (perpendicular to the disc surface) as well as in radial (perpendicular to the track and in then plane of the disc) direction. Deviations from track and optimal focus position may, for example, lead to reduction in the quality of the reproduced data or in off-track data during recording.

An example of a well-known focusing method is the astigmatic focusing method. However, also other focusing methods may be applied such as the knife-edge (Foucault) focusing method or spot size detection focusing method. For the tracking methods there is also a number of well-known possibilities such as, for example, the push-pull tracking method or the three beam (or three spots) tracking method.

A commonly applied combination of focusing and tracking method for recordable optical disk systems is the astigmatic focusing method with the three spots differential push-pull tracking method. For example, a cylindrical lens and/or plan-parallel plate may be used to generate the astigmatism for the astigmatic focusing method into the radiation beam towards the radiation detector. A diffraction grating may be applied to generate a main and two satellite radiation beams out of the radiation beam emitted by the radiation source, e.g. a semiconductor laser. A commonly applied intensity ratio for the intensity of the main radiation beam with respect to intensity in each satellite beam is about 10 to 15 over 1 for recordable systems, but may have a different ratio. A high radiation power level in the main beam is advantageous for the recording speed in the application.

A radiation detector geometry suitable for cooperation with the astigmatic focusing three spots differential push-pull tracking method comprises a main detector and two satellite detectors (opposite with to each other with respect to the main detector).

The main radiation beam reflected by the information layer in the disk is projected via the objective lens onto the main detector, which is used for generating the data readout signal (data signal). The main detector is usually also split up into four quadrant segments (corresponding to a radial and a tangential direction with respect to the tracks on the disk) to be able to generate a focus error signal based on the astigmatic method. The satellite beams reflected by the information layer are each projected via the objective lens onto one of the satellite detectors. Each satellite detector is split up into two segments (corresponding to the radial direction with respect to the tracks on the disk) in order to be able to generate a push-pull signal per satellite beam. By combining the push-pull signals of the main and two satellite detectors a three spots differential push-pull signal can be generated as radial tracking error signal. The focus error signal and radial tracking signals are used in servo control electronics to accurately align the scanning spot onto the track to be scanned.

Multilayer disks, such as the dual-layer BD, comprise of a stack of two information layers L1 and L0 separated by a spacer layer of about 25 μm and the total covered by a transparent cover layer of 0.075 mm thickness (a single layer BD disc has a transparent cover layer of 0.1 mm thickness). L1 may be assumed to be the closest to the radiation incident surface of the disk, while the L0 is then assumed to be farther away from the radiation incident surface of the disk. L1 is not fully reflective as it is preferable to scan the L0 layer in order to make use of the capacity of this second information layer. Hence, while scanning the L1 information layer, some radiation is transmitted towards the L0 information layer and reflected back into the objective lens to be projected towards the radiation detector. When scanning the L0 information layer the L1 information layer also reflects some radiation that is projected towards the radiation detector. In both situations these additional reflected radiation beams may cause unwanted radiation to occur on the main and satellite detectors which may cause optical interferences with the radiation spots of the reflected main and satellite beams on the detector related to the scanned information layer.

When the spacer layer between L0 and L1 is varying in thickness, for example, along the track and/or perpendicular to the track direction, the resulting interference patterns are also varying causing crosstalk. As a result the focus and/or tracking error signals or the data signal may be disturbed by this crosstalk, which may result in incorrect tracking, focusing and/or data recording or data reproduction.

As the intensity of the satellite beams projected onto the satellite detectors is in recordable systems much lower than the intensity in the main beam, the effect of the crosstalk on the tracking error signal, such as the push-pull signals, can be that large such that scanning of dual-layer media is becoming unstable.

European Patent Application EP1555664A2 discloses an optical scanning device capable of scanning multi information layer media such as dual-layer BD. It discloses an optical element comprising a diffractive structure, such as a grating or a polarizing or non-polarizing diffractive optical element (DOE), which diffracts that part of the radiation beam reflected by the other information layer than the layer that is scanned from being projected by the objective lens onto the two satellite detectors. The radiation is diffracted out of the optical path to the detector areas for the satellite and main radiation beam. Depending on the size and pattern of the diffractive structure of the optical element also light reflected from the other information layer towards the main detector is inhibited.

As the optical element comprising the diffractive structure also removes parts of the radiation beam reflected by the information layer being scanned, the quality of the data signal is reduced, for example resulting in a higher jitter value. By applying an additional detector element the diffracted parts of the radiation beams reflected by both the scanned information layer as well as the other information layer(s) can be detected and added to the data signal. The impact of the interferences on the main beam is assumed to be less than that on the satellite beams as the radiation intensity is much higher.

Applying the proposed solution of EP1555664A2 in a multi disc type data drive has disadvantages. The diffractive structure of such an optical element also has effect on the DVD or CD radiation beam when scanning a DVD or a CD when the optical element is in a common optical path of the BD and DVD and/or CD lightpaths of an OPU for a multi disc type data drive. The diffractive structure removes light out of the radiation beam towards the detector. The diameter of the radiation beams for scanning a BD, DVD and CD in a BD/DVD/CD compatible optical scanning device is proportional to the NA of the objective lens. When applying e.g. a single BD/DVD/CD compatible objective lens the respective beam diameters scale with the NA. The beam diameter of a 660 nm radiation beam towards the objective lens used for scanning a DVD is about a factor 0.60/0.85 smaller than the BD beam diameter when scanning a BD. Also the beam diameter of the radiation beam towards the detector scales with this ratio. The impact of the diffractive structures with respect to the amount of radiation removed from the radiation beam towards the detector is thus larger when a DVD is being scanned than when a BD is being scanned. When a CD is being scanned with a 785 nm radiation beam the impact is even larger as the effective beam diameter towards the detector or objective lens is about 0.5/0.85 smaller than the BD beam diameter. This means a large amount of the radiation beam comprising RF (data) information is being removed from the DVD or CD radiation beam towards the detector, resulting in a decrease in readout performance (e.g. increased jitter). Although European patent application EP1555664A2 discloses the possibility of an additional DVD and/or CD scanning functionality, there is neither teaching nor disclosure on how such functionality should be integrated into the optical scanning device as disclosed without the DVD and/or CD beam to be affected by the disclosed optical element.

It is an object of the invention to provide a multi disc format compatible optical scanning device for scanning a multiple information layer optical recording medium with reduction of the influence of the radiation reflected by other layer than the layer being scanned.

### SUMMARY OF THE INVENTION

In accordance with the invention, there is provided an optical scanning device for scanning a first type of optical recording medium having multiple information layers and for scanning a second type of optical recording medium having an information layer, the optical scanning device comprising a first radiation source for generating a first radiation beam having a first wavelength, at least a second radiation source for generating a second radiation beam having a second wavelength different from said first wavelength, an objective lens adapted to focus the first radiation beam onto an information layer of the first type optical recording medium and adapted to focus the second radiation beam onto an information layer of the second type optical recording medium, a radiation detector for detecting radiation reflected by the information layer of one of the first and second type of optical recording medium being scanned, a filtering means for removing and/or redirecting radiation from the radiation beam reflected by another information layer than the information layer being scanned while scanning the first type of optical recording medium, in which the filtering means transmits substantially unaffected the radiation reflected from the information layer when scanning the second type optical recording medium.

The filtering means filters radiation reflected by another layer than the layer being scanned when scanning a multi information layer optical recording medium of the first type (e.g. BD). This reduces the crosstalk due to interference on for example the tracking error signals to be generated. The filtering means does not affect the radiation beam when scanning an information layer of an optical recording medium of a second type (e.g. a DVD or a CD) and therefore all radiation reflected by the information layer being scanned towards the detector can be used for RF-signal generation and/or focus and tracking error signal generation. The scanning performance of the second type of optical recording medium is thus not affected.

According to an embodiment, the filtering means comprises a center portion for transmitting substantially unaffected the radiation from the radiation beam reflected by the information layer being scanned while scanning the first type of optical recording medium.

This will improve the data signal quality (e.g. jitter) of the information layer being scanned, as a substantial amount of data information is present in the center portion of the radiation beam reflected by the layer being scanned. By having a center portion that is not affecting the reflected beam by the scanned layer, the data reproduction is improved.

According to a further embodiment the filtering means comprises at least filtering portions opposite to each other with respect to said center portion for removing and/or redirecting radiation from the radiation beam reflected by another information layer than the information layer being scanned while scanning the first type of optical recording medium.

These filtering portions inhibits light reflected by an information layer not being scanned to reach the detector and thus avoids the generation of interference with the radiation reflected by the information layer being scanned.

In a yet further embodiment the radiation detector of the optical scanning device comprising at least a main, first and second set of detector-elements, the optical scanning device further comprising a means for generating out of the first radiation beam at least a main radiation beam and at least first and second satellite radiation beams, a projecting means for projecting the main and at least first and second satellite radiation beams reflected by the information layer being scanned onto the radiation detector, thereby creating a main spot and at least a first and second satellite spot, the main spot associated with the main set of detector-elements and the at least first and second satellite spots with the first and second set of detector-elements, the filtering means is having a center portion comprising at least filtering portions opposite to each other with respect to the center portion for removing and/or redirecting radiation reflected by another information layer than the information layer of the first type of optical recording medium being scanned that is projected by the projection means towards the first and second set of detector elements.

This allows for a stable three beam tracking method (e.g. three beam central aperture or three beam push-pull) as the parts of radiation beams reflected by the layer not being scanned are inhibited from reaching the first and second satellite detectors and thus avoiding interference with the created spots of the reflected satellite beams.

In embodiment the filtering means is wavelength selective, which makes it possible to have a wavelength selective function of the filtering means. The filtering means may require to operate while scanning a first type of optical recording medium, while required not to operate when scanning a second type of optical recording medium.

According to embodiments of the invention this wavelength selectivity may be achieved by applying a thin-film or dielectric coating, or by applying a diffractive structure.

Such a thin film optical coating can be made substantially fully reflective for a first wavelength (e.g. 405 nm) and substantially fully transparent for another, second wavelengths (e.g. 660 nm or 785 nm). Such a coating can be a dichroic or trichroic optical coating. The optical coating characteristics (such as reflection and transmission) may also be dependent on the polarization direction of the incident radiation.

According to another embodiment it is preferable that when applying such a dichroic or trichroic optical coating the phase relation of the optical waves of the radiation having the second wavelength transmitted through the filtering portions and outside the filtering portions is maintained. This will improve the optical quality of the transmitted radiation beam. This is especially advantageous when the filtering means is positioned in the radiation path towards the optical record medium for the second radiation beam.

When applying a diffractive structure it is preferable that the phase depth of the diffractive structure is substantially equal to a multiple of the wavelength of the second radiation beam as in that case the filtering means is substantially invisible for the second wavelength, i.e. it has substantially no effect on the transmitted second radiation beam.

In a further embodiment, the optical scanning device further comprising a separation means for separating the radiation beam generated by the first radiation source from the radiation beam reflected by the information layer of the first type optical recording medium being scanned, characterized in that the filtering means is located between the separating means and the radiation detector.

Located in this position the filtering means has no impact on the radiation beam towards the disc. Hence, it is advantageous on the quality of the scanning spot and the transmission of radiation (optical power) towards the disc for data recording. High recording speeds require high radiation power in the focused radiation spot on the disc.

In another embodiment the optical scanning device is adapted for scanning also a third type of optical recording medium with a radiation beam having a third wavelength, the filtering means transmitting substantially unaffected the radiation reflected from the information layer when scanning a third type of optical recording medium.

Such an embodiment is advantageous in the application of for example a BD/DVD/CD compatible data drive in which at least these three types of optical recording media can be scanned (read and/or write). When applying e.g. a single BD/DVD/CD compatible objective lens the respective beam diameters scale with the NA, in which case the diameter of the effective scanning beam for DVD and even more for CD is much smaller than for BD. The impact of a filtering portion or portions in the filtering means affecting these scanning beams or reflected scanning beams my result in a strong reduction of data reproduction quality e.g. an increased read and/or write jitter.

These and other aspects of the invention will be apparent from and elucidated with reference to the embodiments described hereafter.

### BRIEF DESCRIPTION OF THE DRAWINGS

FIG. 1 shows the schematic of an example of an optical scanning device according to the prior art scanning a dual layer optical recording medium.

FIG. 2 shows an example of a detector structure and radiation distribution of an example of the optical scanning device scanning of FIG. 1.

FIG. 3 shows the schematic of an example of an optical scanning device according to the prior art scanning a dual layer optical recording medium.

FIGS. 4A and 4B show an example of the radiation distribution on a detector structure (FIG. 4A) when a filtering means (FIG. 4B) is applied in the optical scanning device according to a first embodiment of the invention.

FIGS. 5A and 5B show an example of the radiation distribution on a detector structure (FIG. 5A) when a filtering means (FIG. 5B) is applied in the optical scanning device according to a second embodiment of the invention.

FIGS. 6A and 6B show an example of the radiation distribution on a detector structure (FIG. 6A) when a filtering means (FIG. 6B) is applied in the optical scanning device according to a third embodiment of the invention.

FIG. 7 shows the schematic of an example of an optical scanning device according to an embodiment of the invention scanning a dual layer optical recording medium.

FIGS. 8A, 8B and 8C schematically show the effects on an optical wave transmitted through a filtering means according to an embodiment of the invention (FIG. 8A), through a preferred embodiment of the filtering means according to the invention (FIG. 8B) and the schematics of the filtering means according to a preferred embodiment of the invention (FIG. 8C).

### DETAILED DESCRIPTION OF THE INVENTION

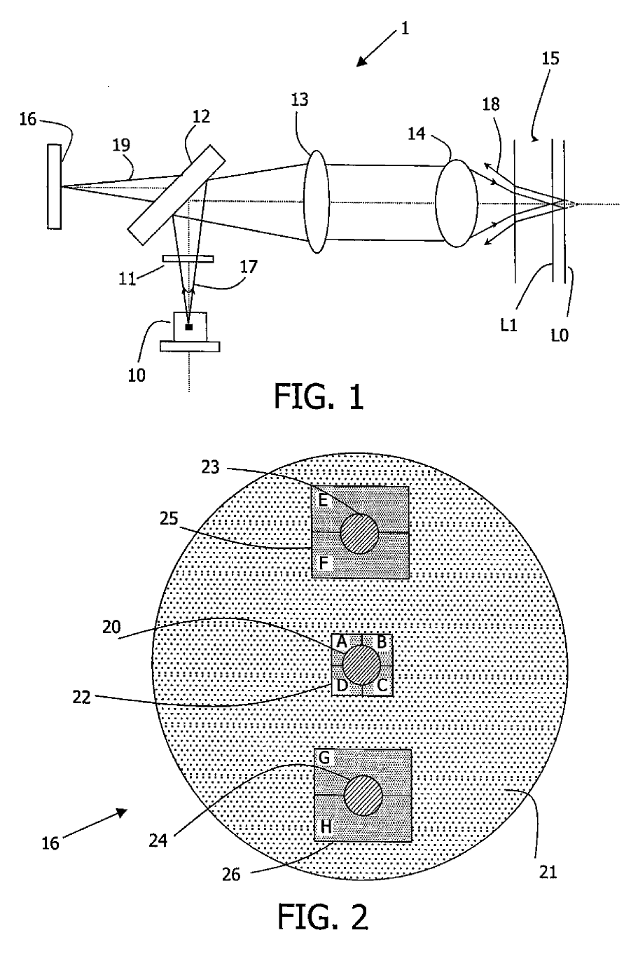

FIG. 1 shows a schematic set up of an example of an optical scanning device 1 for scanning a multi information-layer recording medium 15, such as for example BD, according to a prior art without any filtering means according to the invention. A radiation source 10 (e.g. a semiconductor laser) emits a radiation beam 17. A beamsplitter 12 reflects the radiation beam towards a collimator lens 13 that collimates the radiation beam to a parallel radiation beam that is focused by the objective lens 14 onto an information layer, in this figure on layer L1, of an optical record carrier 15. The objective lens can be a single-lens or multiple-lens objective lens. The optical scanning device may comprise other optical components, such as a quarter wave plate or a sensor lens, but these are not shown in FIG. 1. The light reflected by information layer L1 is reflected back into the optics and imaged (or projected) onto the detector. Layer L1 can be scanned by the focused radiation beam using well known focusing and tracking error methods, such as for example the astigmatic focusing method and push-pull tracking method, and the related servo controls and actuators (not shown) for actuating e.g. the objective lens and/or the optical scanning device with respect to the track(s) on the information layer. The beamsplitter 12 in this example generates astigmatism in the radiation beam 19 towards the detector 16. When applying another type of beamsplitter such as e.g. a prism type or diffractive type the astigmatism has to be introduced by other means, such as an additional cylindrical lens or a astigmatism introducing diffractive optical structure.

As L1 information layer is transmitting part of the focuses radiation beam towards another layer L0, which is not being scanned, some radiation 18 is reflected by L0 back into the optics. The optical system images, or projects, also this reflected radiation towards the detector 16. As this radiation is out of focus of the objective lens, the radiation is imaged as a large radiation spot over the detector surface.

FIG. 2 schematically shows the radiation distribution on detector 16 in the situation for the scanning of L1 as described in relation to FIG. 1. Radiation spot 20 is the radiation scanning spot on L1 spot projected by the optics onto a quadrant detector 22 for focus error (FE) signal generation and RF-signal generation according to known methods. For a single spot push-pull astigmatic tracking method the following formula to derive the FE, RF and RE signals from the set of main detector elements A, B, C and D of detector 22 may be applied:

FE=(A+C)−(B+D)

RF=A+B+C+D

The tracking error (RE) signal may be generated by the push-pull method as

RE=(A+B)−(C+D)

The radiation spot 21 is the image of the radiation reflected by the another layer not being scanned (in this case L0). Although drawn with a circle shape in FIG. 2, the actual shape of the radiation spot 21, when applying the astigmatic focusing method, may be elliptical and is also depending on the layer being scanned.

The overlapping portions of radiation spot 20 and radiation spot 21 will show optical interference that may cause fluctuations in the FE, RE and RF signals when the interference pattern is fluctuating due to, for example, variations in the spacer layer thickness between layer L1 and L0.

It can be understood that the above problem is not limited to scanning optical record media having only two information layers.

As also shown in FIG. 1 it is possible to apply the three-beam central aperture tracking method or three-beam push-pull tracking method in the optical scanning device 1. For that the radiation beam 17 is split into a main and two satellite radiation beams by means of, for example, a diffraction grating 11. The main beam has a larger radiation intensity than the two satellite radiation beams. Commonly used ratios for the intensities in optical scanning devices suitable for recording data are 1:10:1 or 1:15:1. However, also other ratios may be applied. The three beams are focused on the information layer being scanned as main spot and first and second satellite spot, according to known methods, orientations and positions with respect to the track(s) on the information layer. The three reflected beams are imaged/projected by the optical system towards the detector and image (see FIG. 2) as a main 20, first 23 and second 24 satellite spot onto the respective set of detector elements 22, 25 and 26. The satellite detectors 25 and 26 may each be split up in order to make a three-beam push-pull tracking possible. The tracking error signal based on the three beam central aperture method can be described using the first and second set of detector elements E, F, G and H of the first and second satellite detectors by:

RE_{3spCA}=(E+F)−(G+H)

When using the three-beam push-pull tracking method the tracking error signal can be described by

RE_{3spPP}=[(A+B)−(C+D)]−Kₚₚ·[(E−F)+(G−H)]

in which Kₚₚ is a gain factor in the electronics for compensating the radiation intensity differences between the main and satellite spots on the detector.

The overlapping portions of radiation spot 21 and the satellite spots 23 and 24 will also show optical interference that will cause fluctuations in the RE-signals when the interference pattern is fluctuating due to, for example, variations in the spacer layer thickness between layer L1 and L0.

The satellite beams focused on the information layer that is scanned will also partially be reflected by the layer not being scanned and will thus also result in a large spot similar to radiation spot 21 onto the various sets of detector elements. However, as the intensity in these satellite beams usually are much less than the intensity in the main radiation beam the disturbances due to optical interference is much less and not causing the main problem to be solved.

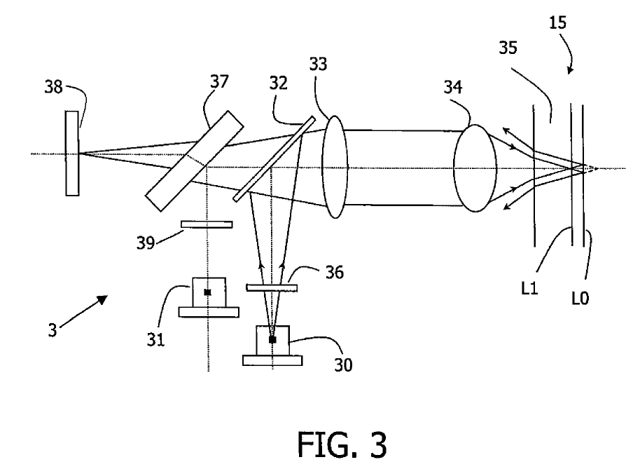

FIG. 3 schematically shows an optical scanning device for scanning a first type of optical recording medium e.g. BD and a second type optical recording medium e.g. DVD or CD. The optical scanning device 3 for scanning a first type of optical recording medium 15, e.g. a BD, having multiple information layers (L0, L1) and for scanning a second type of optical recording medium, e.g. a DVD or CD, having an information layer. The optical scanning device comprises at least a first radiation source 30 for generating a first radiation beam having a first wavelength, e.g. 405 nm for scanning a BD, and at least a second radiation source 31 for generating a second radiation beam having a second wavelength different from said first wavelength, e.g. 650 nm for a DVD or 780 nm for scanning a CD.

When scanning a BD the radiation beam emitted by the first radiation source is reflected by the beamsplitter 32 and transmitted by the collimator lens 33 and focused by the objective lens 34 onto an information layer of the optical recording medium 15. A three-beam grating 36 is applied for generating a main beam and first and second satellite beams. The objective lens 34 is adapted to focus the first radiation beam onto an information layer of the first type optical recording medium through a transparent cover layer 35 and also adapted to focus the second radiation beam onto an information layer of the second type optical recording medium The first and second type optical recording media may have different transparent cover layer thicknesses. The objective lens may thus be a multi optical recording media format compatible objective lens such as, for example, a BD/DVD or BD/CD or BD/DVD/CD compatible objective lens.

The radiation reflected by the scanned layer (e.g. L1) and other layer than the scanned layer (e.g. L0) are imaged/projected onto detector 38 similar as described in relation to FIG. 1, with the exception that beamsplitter 32 is in this example not used to generation astigmatism in the radiation beam towards the detector. It may be e.g. a thin plate or prism type beamsplitter.

When scanning a second type of optical recording medium, e.g. a DVD or CD the second radiation source 31 is used for emitting a second radiation beam that is reflected by a beamsplitter 37, e.g. a plate type beamsplitter, towards the objective lens. The objective lens then focuses the second radiation beam onto an information layer of the second type optical recording medium (not shown). In case of a DVD medium this second type optical recording medium may have one or two information layers.

The radiation reflected by the information layer is then imaged/projected via transmission through the objective lens and collimator lens onto the detector 38. When the beamsplitter 37 is a plate type beamsplitter as shown in FIG. 3, it may be adapted to generate the amount of astigmatism into the radiation beams towards the detector to apply the astigmatic focusing method. It may also be possible that one or more additional optical elements, such as a cylinder lens, are used to generate the required amount of astigmatism in combination with e.g. a cube type beamsplitter. Also other combinations and means may be used to generate the astigmatism for application of the astigmatic focusing method. The forward second radiation path from radiation source 31 to the required position of the optical recording medium to be scanned may also comprise a diffraction grating 39 located e.g. between the radiation source 31 and the beamsplitter 37 for generating a main and first and second satellite beams out of the second radiation beam for a three-beam tracking method.

When applying a filtering means according to a first embodiment in the forward first radiation beam between the first radiation source 30 and the beamsplitter 32 the second radiation beam is not affected by the filtering means. This means there is no radiation power loss due to the filtering means when the optical scanning device is used for scanning a second type optical recording medium such as, for example, a DVD or CD. A disadvantage can be that the filtering means also is filtering out radiation in the forward first radiation beam. As a result the radiation intensity or power for e.g. data recording purposes is reduced, which may limit the maximum data recording speed by then optical scanning device. Another effect may be the reduction of the quality of the scanning spot onto an information layer, resulting in reduced readout quality, e.g. jitter. By keeping the filtering portion or portions as small as possible this power loss may be limited.

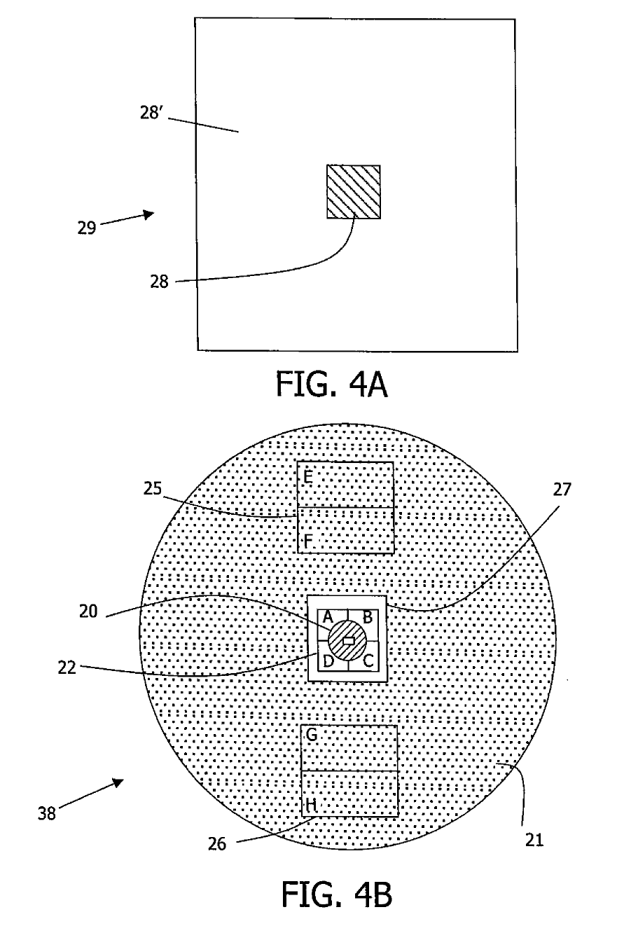

When applying a single beam tracking method for scanning the first type of optical recording medium, such as the one-beam astigmatic push-pull, only filtering portion 28 that will be projected via the scanned disc may suffice to be filtered out by a filtering means 29 as is shown in an example in FIG. 4A. The area 28′ outside the filtering portion 28 can have substantially no filtering effect. The effect of such a filtering is schematically shown in FIG. 4B on a detector 38 which is described in more detail in reference to FIG. 2. The filtering portion 28 is imaged or projected over the set of main detector elements A, B, C and D of detector 22 with the imaged scanning spot 20 via the other information layer than the layer being scanned onto the detector 38 as area 27 within the radiation spot 21 due to the reflected beam from the layer not being scanned. This area 27 is then substantially free of radiation. As only a single beam tracking is applied in this example of a single-beam tracking, no satellite spots are present on the first and second satellite detectors 25 and 26. They may be used when scanning a second type of optical recording medium using a three beam tracking method.

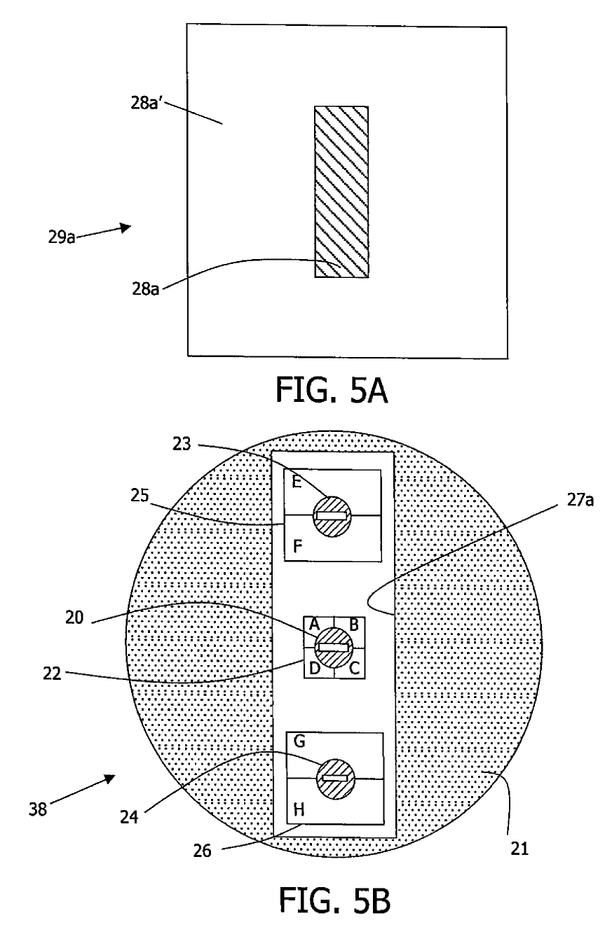

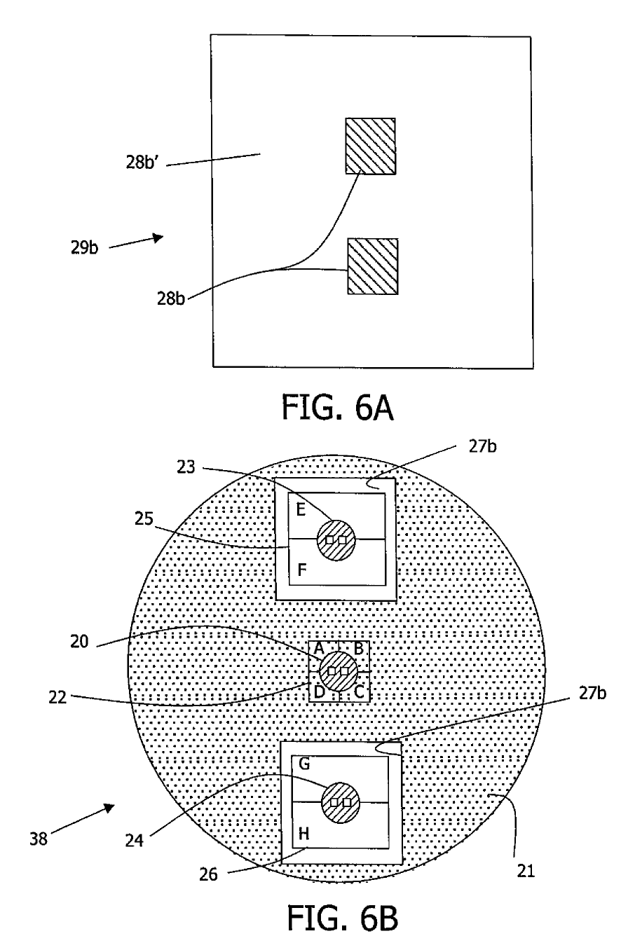

When applying a three beam tracking method for scanning such as a multilayer BD the filtering means may have, for example, a rectangular shaped filtering portion as filtering portion 28a in filtering means 29a in FIG. 5A, or may have as another example three or two square shaped filtering portions 28b in filtering means 29b as in FIG. 6A, that inhibits the radiation reflected by another information layer than the layer being scanned to reach the main set and/or first and second set of satellite detector elements. In FIG. 5A the area 28a′ outside the filtering portion 28a and in FIG. 6A the area 28b′ outside the filtering portion 28b can have substantially no filtering effect.

As the total area of the filtering portions may be large compared to the effective radiation beam diameter at the position of the filtering means, the amount of radiation filtered out may be such that it is limiting the writing or scanning speed of then optical scanning device on such a BD.

In order to increase the radiation intensity towards the optical recording medium and/or towards the detector only filtering portions inhibiting the radiation reflected from a non-scanned layer projected towards the first and second set of detector elements may be used by applying, for example, two filtering portions opposite to a center portion that is transmissive for the first radiation beam. An example is shown in FIG. 6A. As the intensity of the main radiation beam is much higher than that in the two satellite beams the effect of the optical interferences caused by the radiation reflected by the non-scanned information layer has less effect and it may thus be chosen for to have a center portion in the filtering means that is transmissive.

The filtering means may be integrated with or assembled together with another optical component in the optical path between the first radiation source 30 and the beamsplitter 32, such as, for example (and not shown), a pre-collimator lens or a polarization plate.

As the radiation beam is still small in diameter in the part of the optical path between the first radiation source 31 and the beamsplitter 32, an alignment of the filtering means may be required to have the filtering portion projected over the relevant sets of detector elements. It may therefore be more preferable to locate the filtering means in the optical path further away from the radiation source, such as between the beamsplitter 32 and the objective lens 34.

According to a second embodiment the filtering means is located between the beamsplitter 32 and the objective lens 34. The filtering means is removing and/or redirecting radiation from the radiation beam reflected by another information layer than the information layer being scanned while scanning a first type optical recording medium, while it has no effect on or transmits substantially unaffected the radiation reflected from an information layer while scanning a second type optical recording medium. This may be achieved by applying filtering portions based on, for example, a thin-film optical coating or dielectric coating with wavelength specific optical characteristics. Such a thin-film optical coating may comprise a single layer or multiple layer dielectric coating. It is also possible to apply filtering portions having a diffractive structure that has a high diffraction efficiency at the first wavelength and very low diffraction efficiency (so, a high transmission) at the second wavelength.

For the first radiation beam with e.g. a 405 nm wavelength the filtering portion or portions may be, for example, absorptive or reflective, while for a second radiation beam with a second wavelength, such as for example about 660 nm or about 780 nm, the filtering portion or portions are substantially fully transmissive. As known by the skilled person optical coatings with 100% transmission or absorption/reflection are difficult to make. The absorption/reflection of for the first wavelength is preferably higher than 50% and more preferably higher than 75%, while most preferably it is higher than 90%. The transmission of the second wavelength is preferably more than 50%, but even more preferably more than 75%. Most preferably the transmission for the second wavelength is more than 90%. The minimum required value is related to, for example, the required radiation power out of the objective lens 34 for recording data on a second type of optical recording medium, such as DVD or CD.

In case of a three beam astigmatic tracking method the detector may have a structure as schematically shown in FIG. 5B, where a main 22, first 25 and second 26 set of detector elements are shown on detector 38. A projection means projects the main, and at least first and second satellite radiation beams reflected by the information layer being scanned onto the radiation detector, thereby creating a main spot and at least a first and second satellite spot onto the related set of detector elements. The projection means may comprise optical components such as the objective lens, a collimator lens as well as other optical components that are arranged between the scanned information layer and the radiation detector. Some of these optical components may have optical power, while others may have no optical power, such as for example plate type beamsplitters. The imaged scanning spots, the main spot 20 and satellite spots 23, 24, are shown in this FIG. 5B and are used for data signal generation as well as focus error and tracking error signal generation. The focus error signal is generated using the astigmatic focusing method by, for example, determining the resulting signal from the detector elements A, B, C and D by FE=(A+C)−(B+D). The tracking error signal may, for example be generated by processing the signals of individual detector element according to RE=(A+B)−(C+D)−Kₚₚ·[(E−F)+(G−H)], which is a common applied formula for the three beam differential push-pull tracking method.

The filtering means may comprise a filtering portion 28a such as shown in FIG. 5A, which inhibits radiation reflected by another layer than the layer being scanned to reach all sets of detector elements. The shape of the filtering portion 28a is imaged into the radiation distribution 21 of the reflected radiation of the other layer as an area 27a (within the radiation spot 21) with substantially no radiation (as can be seen in FIG. 5B). As the filtering portion also filters portions of the radiation beam reflected by the information layer being scanned, the shape of the filtering portion 28a is also imaged in the main 20 and satellite spots 23, 24 on the detectors 22, 25 and 26. Due to the astigmatic focusing method the image in the spots is rotated about 90 degrees with the imaged area 27a. The shape of filtering portion 28a may also have other shapes such as elliptically or dumb-bell (halter) shaped.

In order to avoid too much radiation loss in the first radiation beam it may be possible to adapt the shape of the filtering portion 28a of the filtering means 29a such that the filtering means comprises a center portion which does substantially not affect the reflected first radiation beam. This may for example be achieved by applying a center transmissive region for the first wavelength in the filtering portion 28a, such that there are at least filtering portions opposite to each other with respect to the center portion.

FIG. 6A shows an example of such a filtering means. Filtering means 29b comprises two filtering positions 28b opposite to a center portion that is not affecting the radiation form the radiation beam reflected by the information layer being scanned. This increases the quality of the data signal as the quality of the scanning spot on the information layer improves as well improves the total radiation power transmission into the scanning spot. It also reduces the filtering out of RF-information present in the reflected radiation beam coming from the scanned information layer with data. These filtering portions are imaged or projected via the optical components in the optical scanning devices and the disc onto first 25 and second 26 satellite detectors of the radiation detector 38 as shown in FIG. 6B. Now two areas 27b that are substantially without radiation reflected from the non-scanned layer occur within the radiation spot 21 as an image of the filtering portion(s). The main detector 22 in this embodiment is not shielded for the radiation from the other layer. The image of the filtering portions 28b appears also about 90 degree rotated in the main spot 20 and first 23 and second 24 satellite spots.

The skilled person, when knowing the invention, can think of various other geometries for the filtering portion or portions, such as circles, ellipses, rectangular shapes, etc., separated by non-filtering portions or connected by other filtering portions.

When the filtering means is located in the forward path of the first radiation beam from radiation source towards the disc, radiation is already filtered out of the radiation beam towards the disc. This may result in a reduction of the optical quality of the scanning spot and thus a reduction of readout quality (e.g. increased jitter).

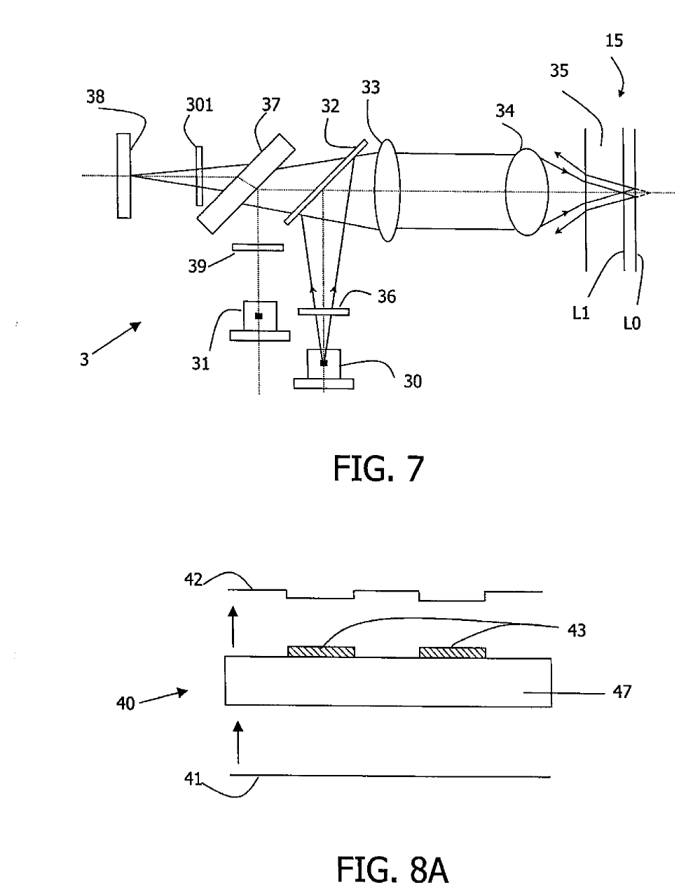

In FIG. 7 an example of an optical scanning device 3 according to another embodiment of the invention is shown with numeral references as described in relation to FIG. 3. The filtering means 301 added in FIG. 7 with respect to FIG. 3 is located between the separating means (e.g. a beamsplitter) 32 and the radiation detector 38. When the filtering means 301 (for example such as 29, 29a or 29b in respectively FIGS. 4A, 5A and 6A) is located between the beamsplitter 32 that is transmitting the reflected first radiation beam towards the detector and the detector 38, the forward radiation beam towards the disc is not affected. This has advantages such as, for example, that there will be no optical power loss towards the disc and no reduction of optical quality of the scanning spot due to the filtering means. Preferably the filtering means is positioned as far away as possible from the detector 38 as then the radiation beam is the largest in diameter, which makes it easier to position and when required to align the filtering means in the radiation beam with respect to the satellite detector positions and or orientations. An additional advantage is, that the further away the filtering means is positioned from the detector the less filtering can be done resulting in smaller filtering portions. This results in less loss in signal quality. Preferably the filtering means has a center portion that can transmit the radiation reflected from the information layer being scanned unaffectedly. This will result in a better quality of the data signal to be obtained from the main spot 20 on the main detector 22 as less information is taken out of the radiation beam.

When during scanning a second type of optical recording medium is scanned with a second radiation beam and the reflected second radiation beam is using the same detector 38 for the data and focus/tracking error signal generation, the filtering means is preferably not affecting the transmission of the second radiation beam as this would only deteriorate the signal level and/or quality of the signals.

When the filtering means is positioned between the detector 38 and the separation means, i.e. beamsplitter, closest in the return optical path to the detector (in FIG. 7 this is beamsplitter 37), the filtering means only affects the reflected radiation beams towards the detector and not any forward radiation beams towards an optical recording medium. This is advantageous as there is no influence on the quality of the scanning spot or laser power on the disc during scanning with either the first or the second radiation beam.

In order to limit loss of radiation in of data signal generation from the reflected second radiation beam towards the detector 38 the filtering means is preferably not affecting the reflected second radiation beam towards the detector. This may for example be achieved by applying filtering portions (such as 28, 28a and 28b in respectively FIGS. 4A, 5A and 6A) that are transmissive for the wavelength of the second radiation beam. This may be achieved by applying filtering portions based on for example a thin-film optical or dielectric coating with wavelength specific optical characteristics. This may then be a single layer or multiple layer thin film or dielectric coating. It may also be possible to apply filtering portions having a diffractive structure which has a high diffraction efficiency at the first wavelength and very low at the second wavelength.

For the first radiation beam with e.g. a 405 nm wavelength the filtering portion or portions may be, for example, absorptive or reflective, while for a second radiation beam with a second wavelength, such as for example about 660 nm or about 780 nm, the filtering portion or portions are substantially fully transmissive. As known by the skilled person optical coatings with 100% transmission are difficult to make. The transmission of the second wavelength is preferably more than 50%, but even more preferably more than 75%. Most preferably the transmission for the second wavelength is more than 90%. The minimum required value is related to, for example, the required radiation power out of the objective lens 34 for recording data on a second type of optical recording medium, such as DVD or CD.

Although the filtering means is described in the embodiments as a transmissive optical component with a transparent substrate through which radiation beams are transmitted, it also may be possible that the filtering means is based on reflection of the radiation beams, e.g. by means of a filtering means being a folding mirror with integrated filtering portions.

For each above-mentioned locations for the filtering means, and especially for the locations in a forward second radiation beam, it is preferable that the phase relation between the optical waves exiting the filtering means through the filtering portions and exiting the filtering means outside the filtering portions is maintained in order to keep the optical quality of the scanning spot, and thus the data reproduction, as good as possible.

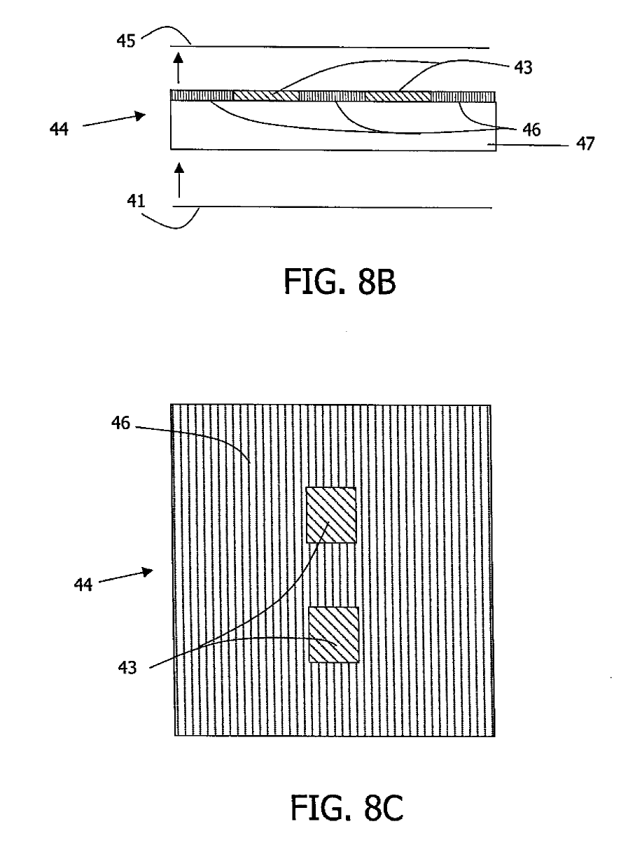

As shown in FIG. 8A a flat optical wave (or wavefront) 41 transmitted through a filtering means 40 having filtering portions 43 on a substrate 47 that are not phase compensated with the surrounding area of the filtering portions, may result in a deformed or disturbed wavefront 42 after the optical wave has been transmitted through the filtering means. Preferably, as show in FIGS. 8B and 8C in relation to filtering means 44, such deformations are avoided by compensating the phase of the waves transmitted through the filtering portions 43 with a phase matching portion 46 in the area outside the filtering portions 43. In this way the phase difference with the optical waves transmitted by the area outside the filtering portions is reduced in optical wave 45 compared to that of optical wave 42 in FIG. 8A. Preferably the phase difference is less than 0.2λ and more preferably less than 0.1λ. As the impact of the phase difference depends also on the dimensions of the filtering portion(s) with respect to the diameter of the second radiation beam at the position of the filtering means may be more useful to define the optical quality, such as the wavefront aberration, in values of wavefront root-mean-square (λ rms). When positioned in the forward second radiation beam the phase difference is preferably less than 50 mλ rms (milli-lambda rms) as then the scanning spot optical quality may remain within diffraction-limited quality.

When the filtering means is positioned in a forward radiation beam of for example a BD/DVD/CD compatible optical scanning device, the filtering portions preferably only filter light of the BD scanning wavelength i.e. about 405 nm out of the BD reflected radiation beam. Preferably the filtering means and/or portions are not affecting the scanning beam used for scanning a DVD (e.g. an about 660 nm wavelength radiation beam) and/or a CD (e.g. with an about 780 nm radiation beam).

An example of a filtering means that can be applied in a BD/DVD/CD compatible optical scanning device according to the invention the filtering means comprises two filtering portions opposite to each other with respect to a center portion. Each filtering portions has a rectangular shape of about 0.7 mm by 0.8 mm. The centers of both filtering portions are 1.3 mm apart. The transmission in the filtering portions for the first wavelength (BD) is less than 5%, while the transmission for the second (DVD) and third (CD) wavelength is more than 95%. In the portions of the filtering means outside the filtering portions the transmission is preferably more than 95% for all three wavelengths. The wavefront aberration due to the filter portions is preferably less than 20 mλ rms for both second and third wavelength.

As alternative for thin-film or dielectric coating is may be possible to apply a diffraction grating that has sufficient diffraction efficiency for radiation of the first wavelength. The diffraction grating preferably has a phase depth of a multiple of the wavelength of the second radiation beam (e.g. for DVD scanning). This makes the filtering portions in the filtering means substantially invisible for the second wavelength, while a sufficient removal and/or redirecting of radiation from the first radiation beam (e.g. for BD scanning) is possible. The diffraction grating may, for example, be a binary phase grating or a blazed grating.

Although the invention is described in detail in relation to an optical scanning device for scanning two types of optical recording media such as BD and DVD, the invention also can be applied in combination with an optical scanning device capable of scanning more types of optical recording media such as for three types e.g. BD, DVD and CD.

Although the invention is described in detail to a three beam tracking method the invention can also be applied to a single beam tracking method such as a single beam push-pull tracking method in combination with an astigmatic focusing method. It may also be possible to apply a differential phase detection method for tracking.

Although the invention is explained in relation to an astigmatic focusing method the invention can also be applied in combination with other focusing methods such as spot-size detection or knife-edge method. Also a differential astigmatic focusing method may be applied.

1. An optical scanning device for scanning a first type of optical recording medium having multiple information layers and for scanning a second type of optical recording medium having an information layer, the optical scanning device comprising:
a first radiation source for generating a first radiation beam having a first wavelength,
at least a second radiation source for generating a second radiation beam having a second wavelength different from said first wavelength,
an objective lens adapted to focus the first radiation beam onto an information layer of the first type optical recording medium and adapted to focus the second radiation beam onto an information layer of the second type optical recording medium,
a radiation detector for detecting radiation reflected by an information layer of one of the first and second type optical recording medium being scanned,
a filter for removing and/or redirecting radiation from the radiation beam reflected by another information layer than the information layer being scanned while scanning the first type of optical recording medium,
wherein the filter transmits substantially unaffected the radiation reflected from the information layer when scanning the second type of optical recording medium.

2. An optical scanning device according to claim 1, wherein the filter comprises a center portion for transmitting substantially unaffected radiation from the radiation beam reflected by the information layer being scanned while scanning the first type of optical record medium.

3. An optical scanning device according to claim 2, wherein the filter comprises at least filtering portions opposite to each other with respect to said center portion for removing and/or redirecting radiation from the radiation beam reflected by another information layer than the information layer being scanned while scanning the first type of optical recording medium.

4. An optical scanning device according to claim 1, the radiation detector comprising at least a main, first and second set of detector-elements, the optical scanning device further comprising
a radiation beam generator for generating out of the first radiation beam at least a main radiation beam and at least first and second satellite radiation beams,
a projector for projecting the main and at least first and second satellite radiation beams reflected by the information layer being scanned onto the radiation detector, thereby creating a main spot and at least a first and second satellite spot, the main spot associated with the main set of detector-elements and the at least first and second satellite spots with the first and second set of detector-elements,
wherein the filter has a center portion comprising at least filtering portions opposite to each other with respect to the center portion for removing and/or redirecting radiation reflected by another information layer than the information layer of the first type of optical recording medium being scanned that is projected by the projector towards the first and second set of detector elements.

5. An optical scanning device according to claim 1 in which the filter is wavelength selective.

6. An optical scanning device according to claim 5, the filter comprising a thin-film or dielectric coating.

7. An optical scanning device according to claim 6, wherein the filter comprises a thin-film optical or dielectric coating designed to substantially fully reflect or absorb radiation having the first wavelength and substantially fully transmits the radiation having the second wavelength.

8. An optical scanning device according to claim 5, the filter comprising a diffractive structure.

9. An optical scanning devices according to claim 8 in which the phase depth of the diffractive structure is substantially equal to a multiple of the wavelength of the second radiation beam.

10. An optical scanning device according to claim 3 in which the phase difference between optical waves of the second radiation beam transmitted through the filtering portions and transmitted outside the filtering portions of the filter is less than 0.2λ.

11. An optical scanning device according to claim 10, in which the wavefront aberration is less than 50 mλ rms.

12. An optical scanning device according to claim 1, adapted for scanning a third type of optical recording medium having an information layer, the optical scanning device further comprising a third radiation source for generating a third radiation beam having a third wavelength, wherein the filter transmits substantially unaffected the radiation reflected from the information layer when scanning a third type of optical recording medium.

13. An optical scanning device according to claim 12, in which the filter is wavelength selective.

14. An optical scanning device according to claim 13, the filter comprising a thin-film or dielectric coating.

15. An optical scanning device according to claim 14, wherein the filter comprises filtering portions comprising a thin-film optical or dielectric coating designed to substantially fully reflect or absorb radiation having the first wavelength and substantially fully transmit the radiation having the second wavelength and third wavelength.

16. An optical scanning device according to claim 12 in which the phase difference between optical waves of the third radiation beam transmitted through filtering portions of the filter and transmitted outside the filtering portions of the filter is less than 0.2λ.

17. An optical scanning device according to claim 16, in which the phase difference is less than 50 mλ rms.

18. An optical scanning device according to claim 1, further comprising a separator for separating the radiation beam generated by the first radiation source from the radiation beam reflected by the information layer of the first type of optical recording medium being scanned, wherein the filter is located between the separator and the radiation detector.

19. An optical recording drive comprising an optical scanning device according to claim 1.
